(19) United States
(12) Patent Application Publication
(10) Pub. No.: US 2023/0002692 A1
(43) Pub. Date: Jan. 5, 2023

(54) SYSTEM FOR COMBINED PRODUCTION OF YELLOW PHOSPHORUS AND SYNGAS

(71) Applicant: Kunming University of Science and Technology, Kunming City (CN)

(72) Inventors: Yi MEI, Kunming City (CN); Chi ZHAI, Kunming City (CN); Yunxiang NIE, Kunming City (CN); Jupei XIA, Kunming City (CN); Delong XIE, Kunming City (CN); Yuanzhi ZHU, Kunming City (CN); Ping LONG, Kunming City (CN)

(21) Appl. No.: 17/853,426

(22) Filed: Jun. 29, 2022

(30) Foreign Application Priority Data
Jun. 30, 2021 (CN) 202110735639.4

(51) Int. Cl. C10J 3/84; C01B 3/02; C01B 3/52; C01B 25/00; C01B 25/047; C10J 3/52

(52) U.S. Cl. CPC C10J 3/845; C01B 3/02; C01B 3/52; C01B 25/003; C01B 25/047; C10J 3/526; C01B 2203/0415; C01B 2203/0465; C10J 2300/0906

(57) ABSTRACT

A system for combined production of yellow phosphorous and syngas is disclosed. The air separation unit, the pulverized coal preparation unit and the mineral aggregate forming unit are respectively connected to a gas inlet and a top feeding port of the phosphorus coal gasifier; phosphorus-containing syngas obtained from phosphorus coal gasifier is connected to a gas inlet of the separating washing unit through an outlet of the phosphorous coal gasifier; Yellow phosphorus products and crude syngas are respectively output from the output port of the separating washing unit; and then the crude syngas is purified to obtain refined syngas. A slag discharge port at the bottom of the phosphorus coal gasifier is connected to an input port of a slag cold quenching unit. The system can improve the available energy of yellow phosphorous production, the production capacity of yellow phosphorus and the yield of syngas, and reduce CO₂ emission.

### CROSS REFERENCE TO RELATED APPLICATION

This patent application claims the benefit and priority of Chinese Patent Application No. 202110735639. 4, filed on Jun. 30, 2021, the disclosure of which is incorporated by reference herein in its entirety as part of the present application.

### TECHNICAL FIELD

The present disclosure relates to the technical field of phosphorus and coal chemical industry, and in particular relates to a method of producing yellow phosphorus and syngas by coupling coal gasification with phosphate rock reduction reaction.

### BACKGROUND ART

Yellow phosphorus is an important chemical raw material, which is the basic product of medicines, pesticides, electronic chemicals and surfactants. At present, the industrial production method of yellow phosphorus is an electric furnace method, that is, the phosphate rock is reduced to elemental phosphorus by means of coke in a high-temperature electric furnace at 1,350 to 1,450° C., the heat required for reducing the phosphate rock is from electric energy, the power consumption for producing 1 ton of yellow phosphorus is as high as 13,800 to 14,500 kWh, and the high-grade electric energy is used for supplying heat for the production of yellow phosphorus, resulting in that the system is low in available energy and limited by the electric furnace, electrodes and electric conductors. As the single phosphorus electric furnace has a yield of only 13 kt/a and a by-product furnace gas quantity of only 5,000 to 5,500 Nm³, it is difficult to realize large-scale utilization. Coal gasification, which is one of the most widely used and mature technologies in the coal chemical industry, is an important link in the synthesis of coal-based chemicals. In the coal gasification process, the temperature at the combustion zone of coal and pure oxygen is as high as 1,800 to 2,000° C., and a large amount of cooling medium are required for discharging heat to maintain the heat balance of the system. Therefore, original two independent systems have the following problems: (1) the reduction of yellow phosphorus requires electrical energy for heat supply; (2) a large amount of heat generated in the coal gasification needs to be discharged; and (3) the total amount of CO produced by carbon reduction of phosphate rock is small and difficult to be used on a large scale.

### SUMMARY

A technical problem to be solved by the present disclosure is how to provide a system for combined production of yellow phosphorus and syngas, which can improve available energy of yellow phosphorus production as well as production capacity of the yellow phosphorus and the yield of the syngas, and can reduce CO₂ emission.

To solve the technical problem above, the technical solution adopted by the present disclosure is that: a system for combined production of yellow phosphorus and syngas comprises a phosphorus coal gasifier, wherein a discharge port of a pulverized coal preparation unit is connected to a pulverized coal inlet of the phosphorus coal gasifier and used for feeding pulverized coal into the phosphorus coal gasifier; a gas outlet of an air separation unit is connected to a gas inlet at the bottom of the phosphorus coal gasifier and used for feeding oxygen into the phosphorus coal gasifier; a mineral aggregate forming unit is connected to a feeding port at the top of the phosphorus coal gasifier and used for conveying raw materials for production into the phosphorus coal gasifier; a furnace gas outlet of the phosphorus coal gasifier is connected to a gas inlet of a separating washing unit; one output port of the separating washing unit is a yellow phosphorus product output port, the other output port of the separating washing unit is a crude syngas output port, and the crude syngas output port is connected to an input port of a purification unit; refined syngas is output from an output port of the purification unit; a slag discharge port at the bottom of the phosphorus coal gasifier is connected to an input port of a slag cold quenching unit, and the slag is discharged from an output port of the slag cold quenching unit.

A further technical solution is that: the phosphorous coal gasifier is a fixed bed reactor, pure oxygen sprayed by the air separation unit and pulverized coal fed by the pulverized coal preparation unit are burnt at the lower part of the phosphorous coal gasifier by using a burner, thus forming a high-temperature coal gasification combustion zone at 1600° C. or above; and by taking the combustion zone as a boundary, massive phosphate rock ore, coke, silica or a spherical mixture of the three fed by the mineral aggregate forming unit are located at the upper part of the phosphorus coal gasifier, and the lower part of the phosphorus coal gasifier is a smelting zone for phosphate rock reduction, at which the phosphate rock undergoes reduction reaction at high temperature to generate yellow phosphorus; coal-gasified CO+H₂ and phosphorus steam gradually rise to the top from the bottom of the phosphorus coal gasification furnace and are fed into the separating washing unit from a gas guide pipe; and the furnace gas temperature is 300 to 700° C., and the operating pressure is 1.5 to 3.5 MPa.

A further technical solution is that: the pure oxygen from the air separation unit and dry pulverized coal from the pulverized coal preparation unit enter the lower part of the phosphorus coal gasifier by means of the burner at a speed of 80 to 120 m/s for coal gasification reaction, a high-speed oxidation gas flow zone and a fixed bed at the upper section of the phosphorous coal gasifier form an arch interface to support solid mineral aggregates at the upper end, and high temperature formed by coal gasification enables phosphate rock and silica from the upper part to form an eutectic mixture in the oxidation gas flow zone.

A further technical solution is that: the raw materials for production in the mineral aggregate forming unit are phosphate rock, coke and silica which are added in the form of lump ore, or two or three of ground phosphate rock, coke powder and silica powder which are added in a pelletizing mode, and the raw materials are fed into the fixed bed at the upper section of the phosphorus coal gasifier through a stock bin after being dried.

A further technical solution is that: the process gas led out from the gas guide pipe at the top of the phosphorus coal gasifier sequentially enters the separating washing unit to separate phosphorus from crude syngas of CO and H₂, and the crude syngas containing CO and H₂ enters the purification unit to obtain refined qualified syngas.

A further technical solution is that: the pure oxygen and pulverized coal are burnt by the burner to form a high-temperature coal gasification combustion zone at 1600° C. or above, or the pure oxygen is introduced via the burner and then reacts with excessive carbon from the mineral aggregate forming unit to form a high-temperature coal gasification combustion zone at 1600° C. or above.

A further technical solution is that: the smelting zone employs high-temperature flue gas for liquid seal, liquid-phase slag discharging, and slag water quenching.

A further technical solution is that: the separating washing unit comprises a dust removal system and a yellow phosphorus condensation system; the furnace gas firstly enters the dust removal system, and the temperature of the furnace gas is kept higher than a dew point temperature of yellow phosphorus to achieve gas-solid separation, then the furnace gas after gas-solid separation enters the yellow phosphorus condensation system to obtain a yellow phosphorus product; the crude syngas containing CO and H₂ enters a purification work section for the removal of sulfur-containing compounds and trace phosphorus compounds, thus obtaining a syngas raw material meeting downstream product processing.

A further technical solution is that: a working flow of the pulverized coal preparation unit is as follows: raw material coal is ground in a coal mill by a grinding roller to reach a target particle size, the wet pulverized coal is dried by hot flue gas from an inert gas generator, and then the dried pulverized coal is brought into a rotary separator by hot inert gas; coarse particles are separated and then returned to the coal mill; the inert gas flow entrains fine-particle pulverized coal to enter a pulverized coal bag type dust remover in which the pulverized coal and the inert gas are subjected to gas-solid separation, and then qualified pulverized coal is conveyed to the phosphorus coal gasifier.

A further technical solution is that: the air separation unit is used for generating O₂ and N₂ and conveying the O₂ to the phosphorus coal gasifier to provide pure oxygen for the burner.

The beneficial effects generated by adopting the above technical solutions are that: compared with a traditional phosphorus electric furnace, the system uses primary energy, thus the heat energy utilization efficiency is high, and the energy cost for yellow phosphorus production is greatly reduced. The use of pressurized reaction not only improves the single-series production capacity of yellow phosphorus, but also significantly increases the total amount of co-produced syngas, which is conducive to the formation of industrial scale effects. For example, the phosphorus coal gasifier can co-produce 20,000 tons/year yellow phosphorus while providing syngas for 300,000 tons/year synthesis ammonia. The production and operation environments are improved by adopting a liquid-phase slag discharging and water quenching technology for lifting the flue gas. By means of dry dust removal, the dust content in the furnace gas is greatly reduced, generation of phosphorus sludge in the yellow phosphorus condensation process is completely eradicated, and a high-purity yellow phosphorus product is directly obtained.

### BRIEF DESCRIPTION OF THE DRAWINGS

The following describes the present disclosure in detail with reference to the accompanying drawings and specific embodiments.

FIG. 1 is a functional block diagram of a system in accordance with an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present invention. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

Numerous specific details are set forth in the following description to provide a thorough understanding of the present disclosure, but the present disclosure may be implemented in other ways than those described herein. Those skilled in the art may make similar generalization without departing from the connotation of the present disclosure. The present disclosure is therefore not to be limited by the specific embodiments disclosed below.

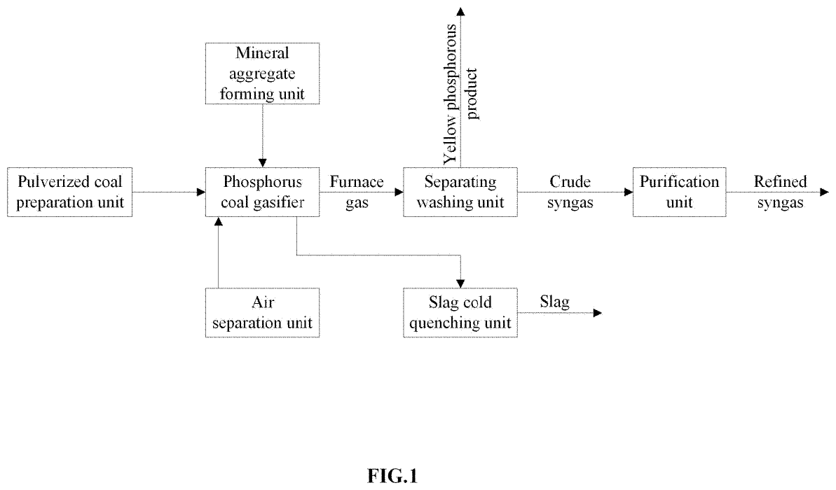

As shown in FIG. 1, an embodiment of the present disclosure discloses a system for combined production of yellow phosphorous and syngas, which comprises a phosphorus coal gasifier, wherein a discharge port of a pulverized coal preparation unit is connected to a pulverized coal inlet of the phosphorus coal gasifier and used for feeding pulverized coal into the phosphorus coal gasifier; a gas outlet of an air separation unit is connected to a gas inlet at the bottom of the phosphorus coal gasifier and used for feeding oxygen into the phosphorus coal gasifier; a mineral aggregate forming unit is connected to a feeding port at the top of the phosphorus coal gasifier and used for conveying raw materials for production into the phosphorus coal gasifier; a furnace gas outlet of the phosphorus coal gasifier is connected to a gas inlet of a separating washing unit; one output port of the separating washing unit is a yellow phosphorus product output port, the other output port of the separating washing unit is a crude syngas output port, and the crude syngas output port is connected to an input port of a purification unit; refined syngas is output from an output port of the purification unit; a slag discharge port at the bottom of the phosphorus coal gasifier is connected to an input port of a slag cold quenching unit, and the slag is discharged from an output port of the slag cold quenching unit.

Further, the phosphorous coal gasifier is a fixed bed reactor, pure oxygen sprayed by the air separation unit and pulverized coal fed by the pulverized coal preparation unit are burnt at the lower part of the phosphorous coal gasifier by using a burner, thus forming a high-temperature coal gasification combustion zone at 1600° C. or above; and by taking the combustion zone as a boundary, massive phosphate rock ore, coke, silica or a spherical mixture of the three fed by the mineral aggregate forming unit are located at the upper part of the phosphorus coal gasifier, and the lower part of the phosphorus coal gasifier is a smelting zone for phosphate rock reduction, at which the phosphate rock undergoes reduction reaction at high temperature to generate yellow phosphorus; coal-gasified CO+H₂ and phosphorus steam gradually rise to the top from the bottom of the phosphorus coal gasification furnace and are fed into the separating washing unit from a gas guide pipe; and the furnace gas temperature is 300 to 700° C., and the operating pressure is 1.5 to 3.5 MPa.

A pressurized fixed bed is adopted for a coupling reaction of the reduction of phosphate rock and coal gasification in the phosphorus coal gasifier, the phosphate rock, coke (coal) and silica enter from the top of the phosphorus coal gasifier, the temperature gradually rises along with descending of materials until the materials are in a smelted state, and the gas temperature of furnace gas at the top of the gasifier is about 500° C.

A working flow of the pulverized coal preparation unit is as follows: raw material coal is ground in a coal mill by a grinding roller to reach a target particle size, the wet pulverized coal is dried by hot flue gas from an inert gas generator, and then the dried pulverized coal is brought into a rotary separator by hot inert gas; coarse particles are separated and then returned to the coal mill; the inert gas flow entrains fine-particle pulverized coal to enter a pulverized coal bag type dust remover in which the pulverized coal and the inert gas are subjected to gas-solid separation, and then qualified pulverized coal is conveyed to the phosphorus coal gasifier.

The pure oxygen from the air separation unit and dry pulverized coal from the pulverized coal preparation unit enter the lower part of the phosphorus coal gasifier by means of the burner at a speed of 80 to 120 m/s for coal gasification reaction, a high-speed oxidation gas flow zone and a fixed bed at the upper section of the phosphorous coal gasifier form an arch interface to support solid mineral aggregates at the upper end, and high temperature formed by coal gasification enables phosphate rock and silica from the upper part to form an eutectic mixture in the oxidation gas flow zone.

The raw materials for production in the mineral aggregate forming unit are phosphate rock, coke and silica which are added in the form of lump ore, or two or three of ground phosphate rock, coke powder and silica powder which are added in a pelletizing mode, and the raw materials enter the fixed bed at the upper section of the phosphorus coal gasifier through a stock bin after being dried.

The pure oxygen and pulverized coal are burnt by the burner to form a high-temperature coal gasification combustion zone at 1600° C. or above, or the pure oxygen is introduced via the burner and then reacts with excessive carbon from the mineral aggregate forming unit to form a high-temperature coal gasification combustion zone at 1600° C. or above.

The process gas led out from the gas guide pipe at the top of the phosphorus coal gasifier sequentially enters the separating washing unit to separate phosphorus from crude syngas of CO and H₂, and the crude syngas containing CO and H₂ enters the purification unit to obtain refined qualified syngas.

The smelting zone employs high-temperature flue gas for liquid seal, liquid-phase slag discharging, and slag water quenching. A slag pool receives liquid slag from the bottom of the fixed bed, the smelted slag enters a conical slag pool at the bottom of the phosphorus coal gasifier through a phosphate rock reduction melting pool for intermittent liquid-phase slag discharging, and the discharged slag enters a slag cold quenching pool and then is discharged after being subjected to water quenching.

The separating washing unit comprises a dust removal system and a yellow phosphorus condensation system. The furnace gas firstly enters the dust removal system, and the temperature of the furnace gas is kept higher than a dew point temperature of yellow phosphorus to achieve gas-solid separation, then the furnace gas after gas-solid separation enters the yellow phosphorus condensation system to obtain a yellow phosphorus product; the crude syngas containing CO and H₂ enters a purification work section for the removal of sulfur-containing compounds and trace phosphorus compounds, thus obtaining a syngas raw material meeting downstream product processing.

In accordance with the system, a reduction reaction system of the phosphate rock is introduced into the coal gasification process, the coal gasification and the phosphate rock reduction reaction are coupled in one gasification device, the heat generated in the coal gasification process is used for supplying heat for phosphate rock reduction, the use amount of cosolvents such as silica is reduced by using silicon and aluminum elements contained in coal ash, thereby increasing the yield of the phosphorus steam. The yellow phosphorus product is obtained by separating the phosphorus steam from CO+H₂, and the crude syngas is further purified to obtain refined syngas. In conclusion, the system can increase the available energy of the yellow production; the single-series yellow phosphorus production capacity and the syngas yield can be improved by means of pressurized conversion; an advanced coal gasification technology is introduced into the yellow phosphorus production process; the phosphorus coal gasifier can receive phosphate rocks of different qualities by means of forming treatment; and CO₂ emission can be reduced.

What is claimed is:

1. A system for combined production of yellow phosphorous and syngas, comprising a phosphorus coal gasifier, wherein a discharge port of a pulverized coal preparation unit is connected to a pulverized coal inlet of the phosphorus coal gasifier and used for feeding pulverized coal into the phosphorus coal gasifier; a gas outlet of an air separation unit is connected to a gas inlet at the bottom of the phosphorus coal gasifier and used for feeding oxygen into the phosphorus coal gasifier; a mineral aggregate forming unit is connected to a feeding port at the top of the phosphorus coal gasifier and used for conveying raw materials for production into the phosphorus coal gasifier; a furnace gas outlet of the phosphorus coal gasifier is connected to a gas inlet of a separating washing unit; one output port of the separating washing unit is a yellow phosphorus product output port, the other output port of the separating washing unit is a crude syngas output port, and the crude syngas output port is connected to an input port of a purification unit; refined syngas is output from an output port of the purification unit; a slag discharge port at the bottom of the phosphorus coal gasifier is connected to an input port of a slag cold quenching unit, and the slag is discharged from an output port of the slag cold quenching unit.

2. The system for combined production of yellow phosphorous and syngas according to claim 1, wherein the phosphorous coal gasifier is a fixed bed reactor, pure oxygen sprayed by the air separation unit and pulverized coal fed by the pulverized coal preparation unit are burnt at the lower part of the phosphorous coal gasifier by using a burner, thus forming a high-temperature coal gasification combustion zone at 1600° C. or above; and by taking the combustion zone as a boundary, massive phosphate rock ore, coke, silica or a spherical mixture of the three fed by the mineral aggregate forming unit are located at the upper part of the phosphorus coal gasifier, and the lower part of the phosphorus coal gasifier is a smelting zone for phosphate rock reduction, at which the phosphate rock undergoes reduction reaction at high temperature to generate yellow phosphorus; coal-gasified CO+H₂ and phosphorus steam gradually rise to the top from the bottom of the phosphorus coal gasification furnace and are fed into the separating washing unit from a gas guide pipe; and the furnace gas temperature is 300 to 700° C., and the operating pressure is 1.5 to 3.5 MPa.

3. The system for combined production of yellow phosphorous and syngas according to claim 1, wherein the pure oxygen from the air separation unit and dry pulverized coal from the pulverized coal preparation unit enter the lower part of the phosphorus coal gasifier by means of the burner at a speed of 80 to 120 m/s for coal gasification reaction, a high-speed oxidation gas flow zone and a fixed bed at the upper section of the phosphorous coal gasifier form an arch interface to support solid mineral aggregates at the upper end, and high temperature formed by coal gasification enables phosphate rock and silica from the upper part to form an eutectic mixture in the oxidation gas flow zone.

4. The system for combined production of yellow phosphorous and syngas according to claim 1, wherein the raw materials for production in the mineral aggregate forming unit are phosphate rock, coke and silica which are added in the form of lump ore, or two or three of ground phosphate rock, coke powder and silica powder which are added in a pelletizing mode, and the raw materials enter the fixed bed at the upper section of the phosphorus coal gasifier through a stock bin after being dried.

5. The system for combined production of yellow phosphorous and syngas according to claim 1, wherein the process gas led out from the gas guide pipe at the top of the phosphorus coal gasifier sequentially enters the separating washing unit to separate phosphorus from crude syngas of CO and H₂, and the crude syngas containing CO and H₂ enters the purification unit to obtain refined qualified syngas.

6. The system for combined production of yellow phosphorous and syngas according to claim 1, wherein the pure oxygen and pulverized coal are burnt by the burner to form a high-temperature coal gasification combustion zone at 1600° C. or above, or the pure oxygen is introduced via the burner and then reacts with excessive carbon from the mineral aggregate forming unit to form a high-temperature coal gasification combustion zone at 1600° C. or above.

7. The system for combined production of yellow phosphorous and syngas according to claim 2, wherein the smelting zone employs high-temperature flue gas for liquid seal, liquid-phase slag discharging and slag water quenching.

8. The system for combined production of yellow phosphorous and syngas according to claim 1, wherein the separating washing unit comprises a dust removal system and a yellow phosphorus condensation system; the furnace gas firstly enters the dust removal system, and the temperature of the furnace gas is kept higher than a dew point temperature of yellow phosphorus to achieve gas-solid separation, then the furnace gas after gas-solid separation enters the yellow phosphorus condensation system to obtain a yellow phosphorus product;
the crude syngas containing CO and H₂ enters a purification work section for the removal of sulfur-containing compounds and trace phosphorus compounds, thus obtaining a syngas raw material meeting downstream product processing.

9. The system for combined production of yellow phosphorous and syngas according to claim 1, wherein the working flow of the pulverized coal preparation unit is as follows: raw material coal is ground in a coal mill by a grinding roller to reach a target particle size, the wet pulverized coal is dried by hot flue gas from an inert gas generator, and then the dried pulverized coal is brought into a rotary separator by hot inert gas; coarse particles are separated and then returned to the coal mill; the inert gas flow entrains fine-particle pulverized coal to enter a pulverized coal bag type dust remover in which the pulverized coal and the inert gas are subjected to gas-solid separation, and then qualified pulverized coal is conveyed to the phosphorus coal gasifier.

10. The system for combined production of yellow phosphorous and syngas according to claim 1, wherein the air separation unit is used for generating O₂ and N₂ and conveying the O₂ to the phosphorus coal gasifier to provide pure oxygen for the burner.
